(19) United States
(12) Patent Application Publication
(10) Pub. No.: US 2009/0133517 A1
(43) Pub. Date: May 28, 2009

(54) Mechanical Tri-Wheel Retention Assembly for Stair-Climbing Wheeled Vehicle

(75) Inventors: Steven Kamara, Princeton, NJ (US); Michael Yang, Princeton, NJ (US)

Correspondence Address: Saul Ewing LLP (Philadelphia), Attn: Patent Docket Clerk, 2 North Second St., Harrisburg, PA, 17101, US

(73) Assignee: STERRACLIMB LLC, Princeton, NJ (US)

(21) Appl. No.: 12/254,854

(22) Filed: Oct. 21, 2008

Related U.S. Application Data
(63) Continuation-in-part of application No. PCT/US2008/001870, filed on Feb. 12, 2008.
(60) Provisional application No. 60/900,813, filed on Feb. 12, 2007.
(60) Provisional application No. 61/021,167, filed on Jan. 15, 2008.

(51) Int. Cl. F16H 35/18

(52) U.S. Cl. 74/10.29

(57) ABSTRACT

While there have been described herein the principles of the invention, it is to be a mechanical tri-wheel retention assembly for a stair-climbing wheeled vehicle having a tri-wheel assembly. The ass has a tri-lobular roller cam mechanism to retain the tri-wheel at a desired angular position for normal two-wheeled operation, and further includes a spring-loaded roller that is configured to pop out of a locking mode in the event of an overload condition, permitting rotation of the tri-wheel assembly to a next predetermined angular position at which point the tri-wheel assembly will be retained, thus preventing damage to the unit and the locking mechanism. The mechanical tri-wheel retention assembly may further include a solenoid actuator configured to automatically disengage the mechanical tri-wheel retention assembly.

### CROSS-REFERENCE TO RELATED APPLICATIONS

This application is a continuation-in-part of PCT Application No. PCT/US2008/001870, filed Feb. 12, 2008, which claims the benefit of U.S. Provisional Patent Application No. 60/900,813, filed Feb. 12, 2007, and U.S. Provisional Patent Application No. 61/021,167, filed Jan. 15, 2008, the entire disclosure of each of which is hereby incorporated herein by reference.

### FIELD OF THE INVENTION

The present invention relates generally to stair-climbing wheeled vehicles, and more particularly to an electrically-powered, driven-spider, stair-climbing wheeled vehicle, such as a hand truck, having a microprocessor-controlled fixed-spider mode for facilitating balancing and maneuvering of the vehicle.

### DISCUSSION OF THE RELATED ART

Stair-climbing hand trucks, wheelchairs, and other wheeled vehicles (collectively, vehicles) have been known for more than a century, but electrically-powered vehicles having the ability to climb stairs are a relatively recent innovation. Many such vehicles are complex, expensive, and difficult to use, requiring deft manipulation of various manually-operable control levers and switches mastered only after substantial training.

There have been numerous attempts to create a stair-climbing vehicle based on a spider, or wheel-over-wheel, design. While tri-wheel spider assemblies are well-suited for stair climbing, they have substantial steering problems when used on flat ground. Since a pair of tri-wheel spider assemblies naturally has four wheels (two of each spider) in contact with the ground, it is much more difficult to turn the vehicle, and a turning radius much larger than a conventional hand truck's, which only has two wheels in contact with the ground, is required.

There have been various approaches to addressing this problem. A simple approach involves inclusion of a manually-operable mechanism that mechanically locks the spiders in positions such that only two wheels (one of each spider assembly) touch the ground during rolling transport. For example, various chain-and-sprocket mechanisms have been used to achieve two-wheel locking, but they significantly increase the cost and weight of the vehicle. The chains are also under extreme tension, and can pose a reliability or safety hazard in the event of failure.

Mechanical pin-based systems require the tri-wheel assembly to rotate to a precise angle, at which point a locking pin is inserted to lock the assembly at an angle that allows the unit to be manually tipped onto two wheels. The main problems with the mechanical pin method are strength and complexity. The tri-wheel assembly must be aligned exactly prior to pin insertion, which may be difficult to accomplish without extensive user effort. The pin may also be difficult to retract under load to transition to stair-climbing mode. As with the chain-and-sprocket approach, the components are also under considerable mechanical stress, and thus will be relatively heavy.

Both designs use a rigid locking system, which will not tolerate shocks and impacts well. For example, it would be relatively common for the hand truck to experience impacts when rolling over curbs and other bumps. The chains or pin lock could easily experience peak stresses 5 or more times higher than the average static stress, but the parts must be designed to withstand the peak stress, which will increase weight and production costs.

A complex approach, employed in passenger-carrying wheelchairs, involves inclusion of motors, sensors, and feedback-based control to cause the wheelchair to actively balance itself, relative to a vertical reference plane, on two wheels (one of each spider assembly).

### SUMMARY OF THE INVENTION

The present invention provides a mechanical tri-wheel retention assembly that avoids rigid tri-wheel locking and associated mechanical failure in the event of an overload condition, and that also avoids extensive power consumption. The mechanical tri-wheel retention assembly that does not fixedly lock the tri-wheel assembly, and permits rotation and relocking of the tri-wheel assembly in the event of an overload condition. Unlike pin-type or level-type, or other manually-operated mechanical locks that fixedly lock the tri-wheel assembly to a frame, etc., the inventive mechanical tri-wheel locking assembly uses a tri-lobular roller cam mechanism to retain the tri-wheel at a desired angular position for normal two-wheeled operation, and further includes a spring-loaded roller that is configured to pop out of a locking mode in the event of an overload condition, permitting rotation of the tri-wheel assembly to a next predetermined angular position at which point the tri-wheel assembly will be retained, thus preventing damage to the unit and the locking mechanism.

The mechanical tri-wheel retention assembly may further include a solenoid actuator configured to automatically disengage the mechanical tri-wheel retention assembly. When used in combination with an electronically-controlled angular locking mechanism, this permits seamless transition to electronically-controlled locking mode. This eliminates the possibility of the unit stalling during an ascent attempt if the user forgot to disengage the wheel locks.

The mechanical tri-wheel retention assembly may be incorporated into a stair-climbing wheeled vehicle, which may include a rigid frame supporting a rotatable axle, and a pair of spider assemblies rotatably supported adjacent opposite ends of the axle. Each of the spider assemblies supports a plurality of rotatable wheels coupled to rotate in synchronicity. The vehicle further includes an angular position sensor supported on the frame in position to measure an angular position of one of the spider assemblies relative to the frame. The vehicle further includes an electric motor and a power source supported on said frame and operatively connected to drive the pair of spider assemblies to rotate.

Optionally, the vehicle may further include a controller supported on the frame and operatively connected to the angular position sensor and the power source to cause the electric motor to apply varying rotational torque to the spider assemblies to cause them to maintain a selected angular position relative to the frame as a function of input received from the angular position sensor. Thus, the vehicle “fixes”, or locks or maintains, subject to corrective variations, the spider assemblies at any of several different target angles relative to the frame. Thus, the vehicle includes a feedback system including a magnetic or other absolute angular position sensor, a micro-processor based controller pre-configured with suitable instructions, and the main drive motor.

The spider assemblies have angular ranges/regions of inherent instability when descending stairs. In those regions, under certain conditions, a conventional spider assembly can roll off the edge of the stairs instead of synchronously rotating down them. In certain embodiments, the controller stores instructions identifying a range of angular positions corresponding to such regions, as a function of the tri-wheel or other configuration of the spider assemblies, and the angular position sensor detects the position of the spider assemblies. In such embodiments, the controller actively accelerates the spider-assemblies through the regions of instability, greatly reducing the risk of rolling off the edge of the stairs. This feature greatly increases the safety and ease of use of the product, and is particularly useful for tri-wheel spider assemblies to acceptably meet the expectations of non-professional users.

The vehicle may include a variable engagement clutch and brake system. This clutch can either lock the wheels to the same reference frame as the hand truck frame, or can allow them to spin freely. During ascent and descent modes, the clutch system is essential for providing added driving traction to force the hand truck to climb the stairs, rather than roll off or bounce in place. The clutch also can act as a brake to lock the hand truck to the stairs, reducing the possibility that it would roll off if the user were to stop at some point during ascent or descent. The clutch is electromagnetic and fully controlled by the controller; no user control is required.

Optionally, the vehicle is configured as a hand truck and further includes removable cargo baskets, and a dual-platform load-carrying system. The vehicle may further include wheel-guarding enclosures, and a telescoping, rotatable handle.

### BRIEF DESCRIPTION OF THE DRAWINGS

The present invention will now be described by way of example with reference to the following drawings in which:

FIGS. 1A and 1B are isometric views of an exemplary vehicle in accordance with the present invention;

FIGS. 1C and 1D are rear and isometric views of the vehicle of FIG. 1, shown with selected housings and components removed for illustrative clarity;

FIGS. 2A-2F are schematic illustrations of successive steps of the vehicle of FIG. 1, depicted during stairwell descent;

FIG. 3 shows a schematic side view of the vehicle of FIG. 1, depicted on a steep stairwell;

FIG. 4 is an operational flowchart of the vehicle of FIG. 1;

FIG. 5 is a side-view of the vehicle of FIG. 1, shown traversing horizontally in a two-contact point configuration;

FIG. 6 shows a side-view of an alternative embodiment of the vehicle with supporting stand;

FIG. 7 is a perspective view of yet another alternative embodiment o the vehicle, including two exemplary cargo platforms in accordance with the present invention;

FIG. 8 is a perspective view of the vehicle of FIG. 7, shown supporting exemplary cargo baskets in accordance with the present invention;

FIG. 9 is a perspective view of the vehicle of FIG. 7, showing the upper platform in an inoperable position, in accordance with the present invention;

FIG. 10 is a perspective view of a vehicle similar to that of FIG. 7, showing a telescoping handle in accordance with an alternative embodiment of the present invention;

FIG. 11 is a schematic illustration of various components of the wheeled device, in accordance with the present invention;

FIG. 12 is a block diagram showing schematically various components of an exemplary wheeled vehicle;

FIG. 13 is a front view of an exemplary tri-wheel stair climbing hand truck including the mechanical tri-wheel retention assembly;

FIG. 14 is a side view of the mechanical tri-wheel retention assembly of FIG. 1; and

FIG. 15 is a detailed perspective view mechanical tri-wheel retention assembly of FIG. 2.

### DETAILED DESCRIPTION

The present invention relates generally to stair-climbing wheeled vehicles, and more particularly to an electrically-powered, driven-spider, stair-climbing wheeled vehicle having a microprocessor-controlled fixed-spider mode for facilitating manual balancing and maneuvering of the vehicle. The present invention is applicable to hand trucks, luggage, baby carriages and other wheeled vehicles. A wheeled vehicle in accordance with the present invention includes sensors, an electric motor, and a controller for controlling the motor as a function of input received from the sensors to provide a fixed-spider mode for facilitating manual balancing and maneuvering of the vehicle. Unlike many mechanical designs, the approach of the present invention is essentially electronic, and does not require any significant addition of components or production costs, and avoids end user complexity.

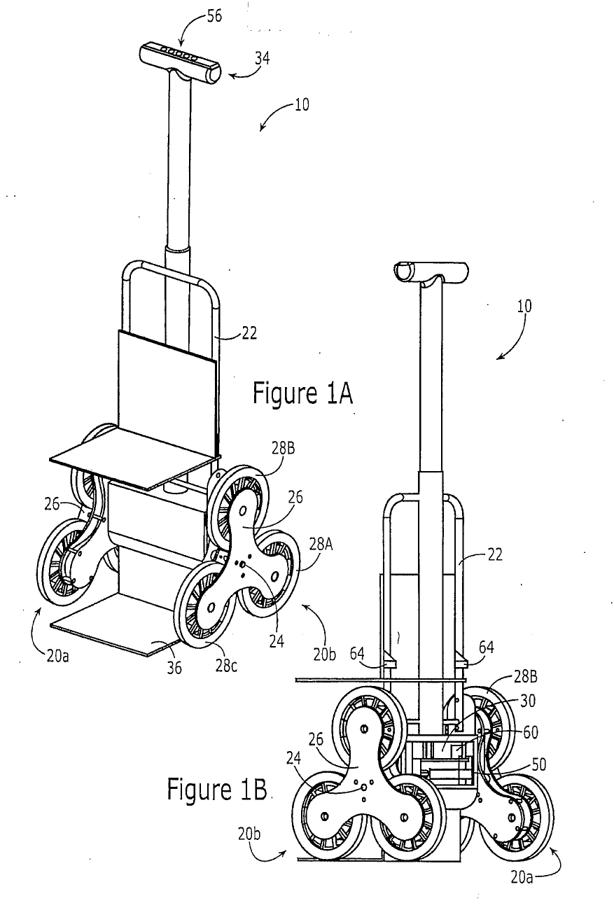

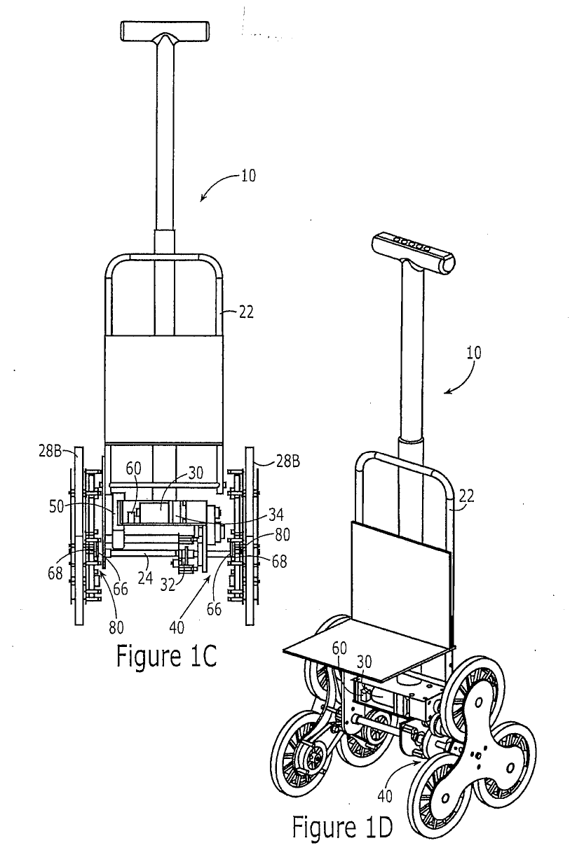

For illustrative purposes, the present invention is discussed below in the context of an exemplary hand-truck vehicle, which is shown in FIGS. 1A-1D. As will be appreciated from FIGS. 1A-1D, the hand-truck includes a rigid frame 22 supporting a rotatable axle 24. The frame supports a load-bearing nose, or platform, 36 of a type typical of conventional hand trucks, and a user handle 34. Symmetrically fixed adjacent both ends of the axle 24 are spider assemblies 20a, 20b, each having a hub 26 supporting equally-spaced rotatable wheels 28A, 28B, 28C in a star-like configuration. A geared motor 30 and battery 50 are supported on the frame 22. The motor 30 and battery 50 are operatively connected, and the motor 30 is operatively connected to the axle 24 by gear train 40 (FIG. 1C) so that rotational torque may be applied by the motor 30 to cause the spider assemblies 20a, 20b to rotate both clockwise and counterclockwise about an axis of axle 24 while frame 22 remains fixed.

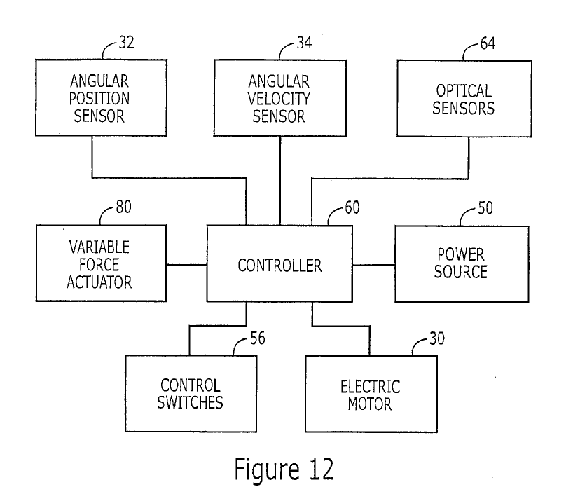

The vehicle 10 includes a microprocessor-based controller 60 configured to receive input from various sensors discussed below, and to control operation of the motor's driveshaft as a function of the input received, as shown in FIGS. 1C, 1D and 12. For example, the controller 60 includes a memory storing software (microprocessor-executable instructions) in accordance with the present invention to dynamically vary the current supplied to the motor as a function of the input received from the sensors, as discussed below.

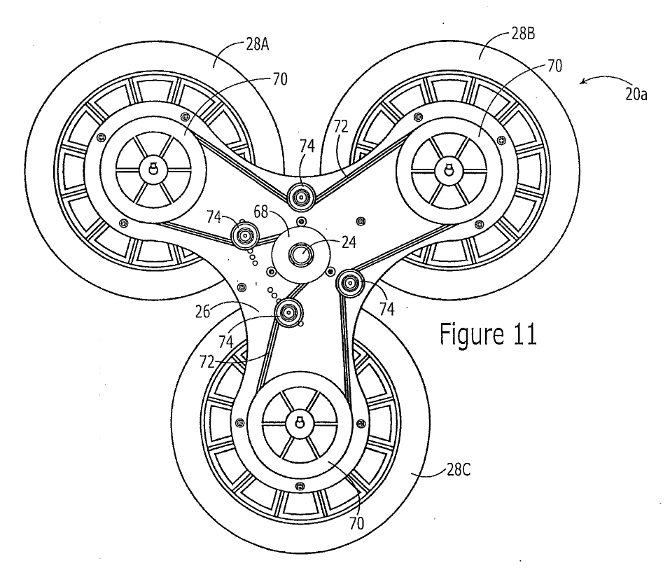

The wheels of each spider assembly 20a, 20b are operatively coupled to rotate in synchronicity, e.g. by gears 70 fixed to rotate with each wheel 28A, 28B, 28C and coupled by a double-sided timing belt 72, as shown in FIGS. 1D and 11. The belt 72 is restrained by idler pulleys 74 to retain the belt 72 within a footprint of the hub 26. The belt 72 engages a clutch 80 that is controlled by the controller 60 to selectively engage, to cause the wheels 28A, 28B, 28C to be driven by the motor 30 to rotate in synchronicity, or to disengage, to permit the wheels to rotate freely in synchronicity.

The vehicle 10 further includes a variable-force actuator 80, such as an electromagnetic clutch, that provides a variable braking force to rotation of the wheels 28A, 28B, 28C about their respective axes. The variable-force actuator 80 is operatively coupled to the controller 60, which controls current supplied from the power source, and thus the amount of braking force applied. See FIGS. 11 and 12. In one embodiment, the electromagnetic clutch 80 includes a coil that is powered by a pulse width modulation circuit controller by the controller 60, allowing a variable level of slip torque to be set. The slip level is important since the clutch should be allowed to slip when maximum torque levels are reached, reducing the probability of overload or breakage.

As best shown in FIGS. 1C and 11, the clutch 80 consists of two primary components, a fixed electromagnetic plate 66, and a rotating actuator plate 68. The electromagnetic plate 66 is fixed to the frame 22, while the rotating actuator plate 68 is supported on the main axle 24 so that it may freely rotate relative thereto. The movable clutch plate is operable to “lock” the central drive pulley to the frame 22 with variable slip torque. The variable force is generated by variation in voltage applied to the electromagnetic plate 66 under control of the controller 60. The rotating plate 68 is integrated into the timing pulley and belt system, such that it rotates synchronously with the wheels 28A, 28B, 28C on each spider assembly 20a, 20b, as best shown in FIG. 11. When engaged, the clutch 80 provides a variable torque between the rotating plate 68 fixed with respect to the wheels (rotatable relative to the axle 24) and the fixed plate 66 fixed to the frame. The clutch 80 locks the central pulley to the frame 22 with variable force. As the wheels and spider hubs 26 rotate around the locked central pulley, the wheels 28A, 28B, 28C are driven to rotate with relation to the frame 22, while they translate in a rotational arc based on the driving of the hubs 26 by the main axle 24. Thus, the wheels are caused to rotate with respect to the frame 22 while the spider assemblies 20a, 20b rotate around them, resulting in a net forward driving force that forces the vehicle 10 into abutting relationship with the base of the stairs, instead of allowing it to fall off or bounce in place. When the wheels of the spider assemblies contact the riser of the next stair, the vehicle can no longer be driven further into the stairs, and the clutch 80 slips to limit the torque on the pulley system.

In accordance with the present invention, the vehicle 10 further includes an angular position sensor 32 (see FIG. 1C) that is mounted to sense an angle formed between frame 22 and spider assembly 20a (e.g., a reference portion of hub 26). By way of example, an absolute optical encoder or an absolute magnetic rotary encoder may be used as the angular position sensor 32. The angular position sensor 32 is mounted to sense the angular position of the spiders relative to a remainder of the frame 22, and to provide angular position feedback to the controller 60. By way of example, the angular position sensor 32 may be fixedly mounted to the axle 24 in position to read markings on the hub 26 as it rotates. Alternatively, the sensor 32 may be integrated into the gear train 40, as will be appreciated by those skilled in the art.

Optionally, the vehicle 10 further includes an angular velocity sensor 34 (see FIGS. 1C and 12), such as an incremental optical encoder. The angular velocity sensor 34 is mounted on the frame 22 (or shaft 24) to sense the angular velocity of rotation of the axle 24 (and thus the hubs 26) and to provide feedback to a the controller 60, which is capable of controlling operation of the motor's driveshaft, as discussed in greater detail below. By way of example, the incremental optical encoder 34 can either be mounted on the main axle 24, or on the motor's shaft, e.g. before the gear train 40. The incremental optical encoder 34 provides a much faster and responsive measurement of velocity than measuring the change in the angular position sensor over time.

The vehicle 10 further includes user-operable switches 56 mounted on the handle 34, as shown in FIG. 1A. The switches 56 are user-operable to select from among ascent, descent, transport and stop operational modes of the hand truck, each of which provides input to the controller and governs how the controller will control the motor, etc. In one embodiment, transport mode is automatically selected by operation of a main power switch, and the stop mode is selected automatically by deselection of either ascent mode or descent mode. The ascent mode and descent mode switches may be momentary spring types, such that all automated operation of the spider assemblies ceases if the user releases the handle 34 or releases one of the switches 56.

The controller 60 is programmed to control operation of the hand truck in the various modes. More specifically, controller 60 is configured to control current supplied to electric motor 30 from power source 50 as a function of input received from one or more of angular position sensor 32, velocity sensor 34, optical sensors 64, and switches 56, in accordance with microprocessor-executable instructions stored in the memory of microprocessor-based controller 60. See FIGS. 1C and 12. Differing instructions are provided for the various modes of operation.

Transport mode is used for transporting luggage, etc. over a substantially flat floor, etc. In this mode, the controller 60 causes the variable-force actuator (electromagnetic clutch) 80 to disengage, and thus permits the wheels 28A, 28B, 28C to rotate freely. The controller 60 receives data from the angular position sensor 32 and causes the motor to rotate the spider assemblies (hubs 26) to one of several (three for a tri-wheel spider assembly, spaced by approximately 120 degrees) predetermined angular positions relative to the frame, and to fix the spider assemblies in the selected angular position. The angular position is such that the vehicle rests with the frame 22 in a substantially upright position, with four wheels (two of each spider assembly) resting on the ground. Upon inclining frame 22 to traverse horizontal surfaces, the spider assembly hub 26 and frame 22 tilt as one fixed unit, the angle between the hubs 26 and the frame 22 being fixed, at which point only two wheels (one on each spider) are positioned to contact the floor during rolling transport of the hand truck. The controller 60 continues to receive angular position data from the angular position sensor 32 as feedback, and to control the motor 30 by varying current from the power source to the motor, to fix the hubs 26 in the selected angular position, e.g. to maintain the predetermined angular relationship between the spiders and the frame, regardless of the position or orientation of the frame/hand truck relative to the floor, or a vertical plane.

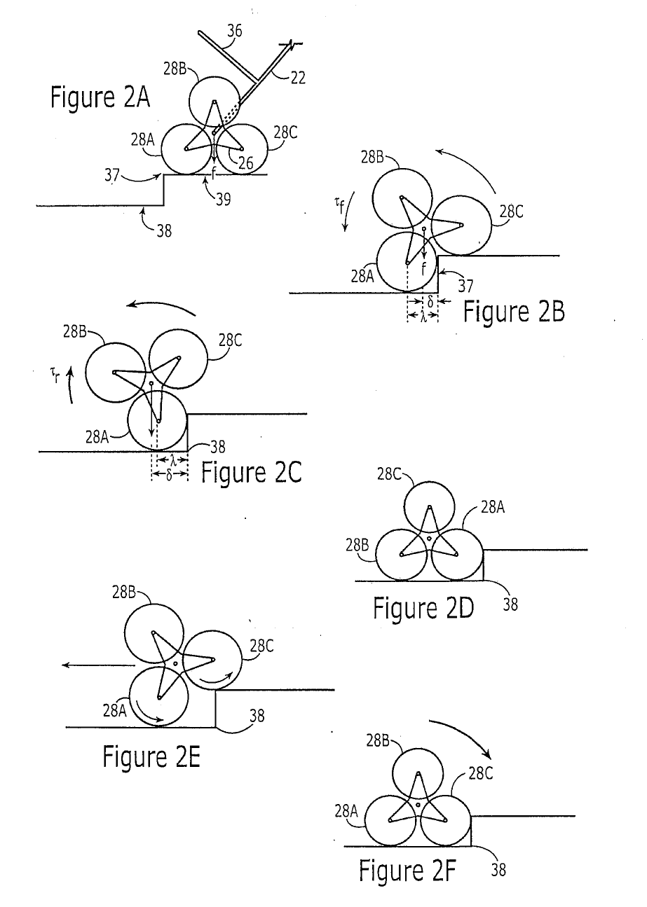

More specifically, the controller 60 uses the angular position sensor 32 to determine the current angle between the hubs 26 and the frame 22, and sets the target angle to the nearest of several acceptable points (one corresponding to each wheel of the tri-wheel assembly). The motor 30 is actively controlled through bi-directional pulse width modulation (PWM) to maintain the target angle. The controller uses a proportional integral derivative (PID) control loop to maintain a stable angular position of the spider assembly hubs. Gradual power ramping is used to prevent any sudden movements or jerking. Accordingly, the relative angular position of the hubs 26 and frame 22 is maintained substantially constant, the frame and hubs tilt as a unit, and the hubs are “fixed” relative to the frame. The unit's turning radius is thus greatly reduced, enabling the turning of tight corners. The locking mechanism may then be disengaged prior to ascent and descent, allowing for the free rotation of the spider wheel as depicted in FIG. 2A.

Thus, regardless of the hand truck's spatial orientation/inclination relative to a vertical plane, etc., the controller, angular position sensor, motor and power source cooperate to maintain a fixed angular position of the hubs 26 relative to the frame 22 in fixed mode.

It will be appreciated that an advantage of the controller's electronic control of the motor to maintain this somewhat resilient “fixed” relationship is the lack of a rigid mechanical restraint that mechanically couples the hubs and frame. According to the present invention, impacts and torque on the hubs mainly act on the motor's electromagnetic field, which is not a breakable mechanical component. The control system thus acts as an electronic shock absorber, and permits the tri-wheel assembly to move by several degrees during impacts, reducing the stress on the power train. In one embodiment, the controller is configured with a present current limit, such that if the hubs experience an exceptionally large impact exceeding a predefined threshold, the motor will hit its preset current limit, and the controller will permit the tri-wheel assembly to rotate to a next sequential predetermined angular position. Once the impact has passed, the controller will retarget a new fixed angle and immediately resume operation, having sustained no damage.

In ascent mode, the leading wheels of the tri-wheel assembly are likely to impinge upon the riser of the step rather than roll onto the tread pull angle has changed significantly from when the user was standing on the ground. To correct the angle and place the two leading wheels on the stairs, controller 60 rotates the spider assembly hubs 26 to an appropriate angular position for starting ascent, and uses feedback from the angular position sensors 32 to varying current/torque applied to the motor 30 to fix the hubs in the appropriate positions relative to the frame 22. The appropriate angular positions position the leading wheels to ensure that they will not interfere with a next step during ascent. In contrast, in transport mode, the angular positions are selected to reduce torque required to fix the hubs relative to the frame by keeping the points of ground contact relatively close to the center of mass (or expected center of mass) of the loaded hand truck, to reduce motor power consumption and to extend battery life.

Further, in ascent mode, the controller 60 causes the variable-force actuator to provide a moderate amount of braking force, e.g., 0-15 inch-pounds of torque or 0-4 pounds of driving force at the contact points of the wheels, to prevent free-spinning of the wheels, to effectively lock rotation of the wheels. This driving torque adds a horizontal component to the force exerted on the stairs, causing the hand truck to “hug” the riser of each stair. Without this force, the spider assembly would tend to exert only a sinusoidal force in the vertical direction, providing no motivation to ascend the stairs without the user's pulling of the unit against the riser of each next stair, and if the user did not pull consistently, the unit could skip a step, bounce in place, or fall down the stairs.

Additionally, the controller 60 causes the motor to drive the spider assemblies to rotate in an ascent-appropriate direction. This locking of the wheels facilitates stability during climbing of stairs as the spiders rotate. The moderate amount of braking force also allows a limited amount of slipping during climbing to allow rotation of the wheels about their axes when a wheel abuts a tread/riser juncture of a staircase, and the associated spider continues to rotate. The controller 60 senses the speed of rotation of the spiders (as determined directly by the velocity sensor 34 or indirectly from data provided by the angular position sensor 32) and controls the motor to vary the spider rotation speed to maintain a substantially constant speed of ascent. In will be noted that the vehicle 10 does not attempt to balance itself, but rather relies upon a person climbing the stairs to guide the hand truck and to provide stability as the hand truck climbs the stairs.

In one embodiment, the vehicle includes stair sensors 64, as best shown in FIG. 1B. Each stair sensor 64 may be a commercially-available infrared optical range finder. The vehicle is configured such that each stair sensor 64 is used to measure a distance from a fixed point on the frame 22 to the nearest surface in a location slightly behind the frame, where a step would likely be encountered prior to starting ascent. The controller 60 is preferably configured to prevent the spider assemblies from rotating, even if ascent mode is selected by the user using the switches 56, if the vehicle 10 is not actually on or adjacent to stairs. Thus, the controller 60 is configured to prevent operation of the spider assemblies in ascent mode, even if ascent mode is selected by the user via the switches 56, if the stair sensors 64 do not detect an adjacent step.

In one embodiment, a pair of optical rangefinders 64 is mounted to the frame approximately 1.5 feet above the ground. These sensors 64 both point downwards and measure the distance from a fixed reference point to the nearest surface. If the distance value decreases by a preset threshold amount, it is likely that the vehicle is in proper position adjacent a step, and the controller will permit the vehicle to enter ascent mode. The use of two or more sensors decreases the likelihood of a false reading due to a user's foot or clothing, by requiring both/all sensors to confirm adjacent step presence simultaneously before permitting driving of the spiders in ascent mode.

If an adjacent step is not detected, the vehicle will not drive the spider assemblies in an attempt to ascend, but will remain in ascent mode until cancelled by the end user. After the first step is detected by the sensors, the controller will cause the motor to drive the spider assemblies and the vehicle will climb as long as the ascent button is held or until ascent mode is otherwise canceled. If the user decides not to ascend the stairs, the vehicle may be returned to transport mode by briefly pressing the descent button or another appropriate one of the switches 56.

In descent mode, the controller 60 causes the variable-force actuator 80 to disengage, and causes the motor 30 to drive the spider assemblies 20a, 20b to rotate in a descent-appropriate direction. In this mode, the controller 60 senses the angular position of the spider assemblies 20a, 20b relative to the frame 22, and causes the motor 30 to accelerate rotation of the spiders through each of three predefined zones of angular positions of the spiders relative to the frame. These zones correspond to zones of instability in which the center of gravity of the loaded hand truck tends to be positioned toward the upstairs side of the axis of rotation of a leading wheel on a lower stair tread. For example, each zone may span angular positions of a respective arm of the spider from a position −10 degrees from vertical to a position +5 degrees from vertical. Due to the weight distribution, the loaded hand truck has a greater tendency to roll along the tread and down the stairs in an unstable manner, than to descend the stairs in a controller manner by rotation of the spiders in these zones of instability. Accordingly, the rapid rotation of the spiders through these zones minimizes any related instability. This rotation has relatively little impact on descent speed, and a substantially constant descent speed is nevertheless maintained.

The controller 60 is preferably configured to provide alternating climb-down and climb-up oriented torque on the spider assemblies during stairwell descent responsive to the absolute rotation angle of the spider assemblies relative to the frame 22. This helps to ensure that the leading wheel remains pinned against the inside corner of a tread/riser interface, thus eliminating the possibility of unintended backward rotation, without imposing any restrictions on the geometry or dimensions of the spider assembly to suit any specific stairwell height. As a result, an advantage is gained that allows for any spider assembly configuration, including a three-wheeled configuration, to properly descend stairwells of any riser height.

The spider assembly 20a, 20b may be selectively driven either clockwise or counterclockwise by the motor 30. The controller 60 is configured to vary motor power based on feedback from the velocity sensor 34 and the absolute angular position sensor 32 to regulate climbing and descent speeds. Since the loading torque on the spider assemblies is sinusoidal, both climbing torque and descent braking alternate in a sinusoidal pattern such that the rotation speed may be maintained substantially constant even though the loading torque and motor power follow a counteracting sinusoidal pattern.

Accordingly, in descent mode, the controller 60, angular position sensor 32, angular velocity sensor 34, motor 30 and power source 50 cooperate to cause acceleration of rotation of the hubs 26 through zones of instability, as predefined and stored in the memory of the controller. This reduces the length of time that the leading wheel is ahead of the center of mass of the hand truck, and thus reduces the length of time that the hand truck remains in an unstable state.

By way of example, in transport mode, the target angle is such that the center of mass is located approximately directly over the center of wheel contact when the frame is tilted for transport, such as approximately 20-45 deg off the vertical. In ascent mode, the target angle may change by about 5-15 degrees to ensure the leading wheels clear an adjacent stair.

While ascending or descending stairs, a user may wish to stop the vehicle so that the user may climb, descend or rest. The controller 60 is configured such that if the ascent button is released while the vehicle is still ascending or descending stairs, the vehicle must stop and rest at a stable angle until the user is ready to either ascend or descend. Accordingly, the vehicle is configured to enter a stop mode in this event.

In stop mode, the controller 60 causes the motor 30 to drive the spider assemblies 20a, 20b to continue to rotate to one of three predetermined angular positions, as determined by feedback provided by the angular position sensor 32. Although the hubs 26 can be stopped and electronically fixed (by the angular sensor/motor feedback loop) at any desired angle, it is particularly stable to stop rotation of the hubs in predetermined positions such that two wheels of the vehicle rest on a lower tread and another two wheels rest on the tread of the next higher step, and the hand truck is positioned in a substantially upright position. The predetermined positions are defined as positions at which the hand truck is expected to stand in a stable manner on stairs of a staircase.

It will be noted that even when ascent or descent has stopped and the spider assemblies have ceased to rotate, the vehicle could roll down the stairs if the user were not to provide adequate holding force. To eliminate such rolling, the controller causes the variable-force actuator 80 to engage (and prevent free-spinning of the wheels 28A, 28B, 28C) to provide a significant amount of locking force that locks the wheels into position and prevents the hand truck from rolling off of the stair treads when a predetermined position is reached. This permits the hand truck to maintain its position, on a stair case, during either ascent or descent of stairs.

To use the vehicle 10 on horizontal surfaces and stairwells, a user grasps the handle 34, and tilts frame 22 until it is inclined with respect to the horizontal, as shown in FIG. 2A. The weight of any load resting on nose 36 produces a downward-directed force f on the hubs 26 of the spider assemblies 20a, 20b. For the purposes of illustrating spider assembly orientation during descent, triangularly symmetric wheels 28A, 28B, 28C are labeled separately in FIGS. 2A-F. As depicted in FIG. 2A, the vehicle 10 starts on a higher tread 39 as it approaches lower riser 38. Lead wheel 28A then rolls over the corner 37 of the higher tread 39 causing the hub 26 to rotate about its center until wheel 28A makes contact with lower riser 38, as shown in FIG. 2B. As shown in FIG. 2B, horizontal distance δ as measured from the riser 37 to the center of rotation of 26 is less than distance λ measured from the center of 28A to riser 37, so that force f produces a clockwise-oriented moment around hub 26 and axle 24. Since α<λ weight has not shifted appropriately to cause 26 to pivot in the climb-down direction around the center of wheel 28A, wheel 28A would tend to roll forward as in FIG. 2E causing wheel 28C to fall suddenly to tread 38, and the spider assembly to turn clockwise as depicted in FIG. 2F.

To avoid this tendency, the controller causes the motor 30 to apply a forward torque τ_{f} in the case that δ<λ, i.e. when the center of hub 26 is not horizontally to the left (in FIG. 2B) of the center pivot point of wheel 28A. Since frame 22 is kept at a reasonably consistent angle of inclination with respect to the horizontal, and angular position sensor 32 measures the angle formed between frame 22 and hub 26, frame 22 effectively measures the orientation of hub 26 in relation to the horizontal by transitive property. Using feedback from angular sensor 32, the controller is thus able to verify when the condition δ<λ holds. As τ_{f} is applied, hub 26 rotates counterclockwise about the central point of wheel 28A until δ>λ as depicted in FIG. 2C. When the condition δ>λ holds, force f produces a counterclockwise-oriented moment around wheel 28A, continuing the direction of rotation of hub 26. The controller then causes the motor to apply a clockwise-oriented reverse torque τᵣ in order to slow the velocity of rotation of hub 26 about the center of wheel 28A. Reverse torque is applied until 26 has reached the flat orientation as depicted in FIG. 2D. Flat orientation is verified by angular position sensor 32, in that the sensor 32 no longer provides feedback to the controller of significant changes in angular position over time. Wheel 28A remains abutting riser 37 while wheel 28B is forward of wheel 28A resting on the lower tread, whereas in the alternate situation attempting to be avoided depicted in FIG. 2F, wheel 28C has fallen to abut riser 37 while wheel 28B does not contact the ground. Having completed 120° of rotation, the unit is once again in the original orientation depicted in FIG. 2A, ready to travel on flat ground or descend another stair in a similar manner as described.

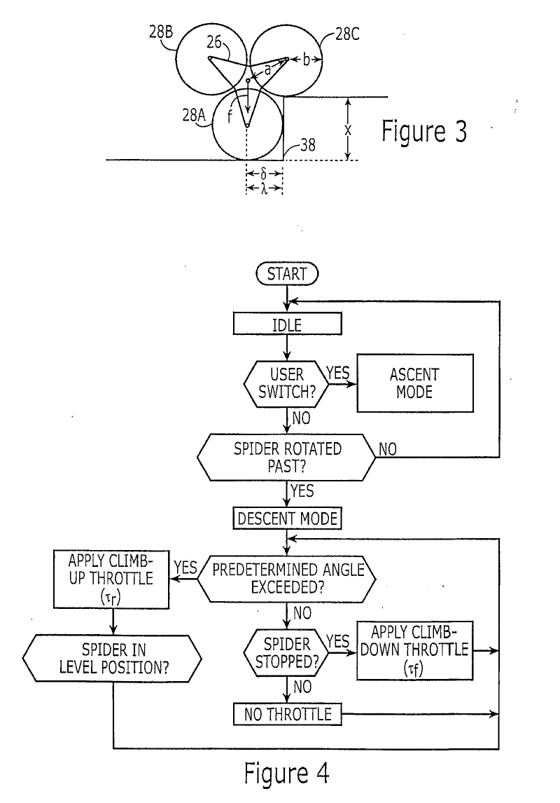

Higher stair risers may be encountered as depicted in FIG. 3 where riser height x, distance a from the center of hub 26 to the center of each wheel, and wheel radius b satisfy the relationship: x>b+a+½ a−b, or more simply, x> 3/2*a. In this situation, forward torque τ_{f} need not be applied during descent, since the condition δ>λ is avoided. FIG. 4 depicts the unit operation in a flowchart as previously described.

One advantage of this embodiment is that it allows for the geared motor 30 to allow for continued rotation of the spider assembly until a predetermined position is attained where at least two of the wheels 28A, 28B, 28C will abut a flat surface. In an unstable position, such as that depicted in FIG. 2C, in which only one wheel remains abutting a surface, should the user let go of an engagement switch indicating a preference to stop mid-stairwell during ascent or descent, the microprocessor will allow for continued counterclockwise-oriented rotation until the orientation in FIG. 2D is reached, whereupon the controller causes the motor to apply a nominal clockwise-oriented torque to the spider, thus fixing the spider in a predetermined position.

Individual stages of the vehicle depicting ascent of stairs are referred to in the reverse sequence, namely, FIGS. 2D, 2C, 2B, 2A. Referring to the spider orientation in FIG. 2C, should the user decide to disengage the switch for ascent, the unit appropriately continues clockwise-oriented rotation until lead wheel 28C rests on the higher tread as depicted in FIG. 2B, before the motor fixes the unit in the attained position as previously described by applying a nominal clockwise-oriented moment. Thus two distinct orientations as depicted in FIGS. 2B and 2D may provide stable positions, i.e. where two of the three wheels remain abutting a stairwell surface.

In should be noted that in selected embodiments, such as in a baby carriage embodiment, an additional set of wheels may be attached to a support stand 40 is mounted to frame 22 to pivot between an inoperative position, and an operative positions facilitating horizontal traversal as depicted in FIG. 6. The vehicle may be equipped with a load-measuring scale that interacts with the controller to adjust motor output as a function of varying loads on the frame.

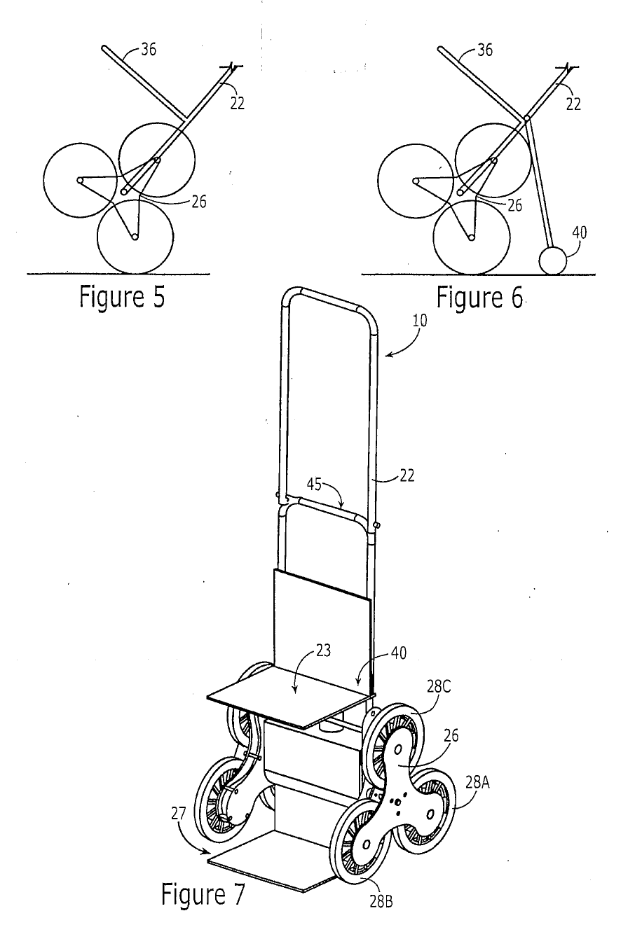

In certain embodiments, the wheeled vehicle is configured as a hand truck 10 including a fixed or foldable base platform, a secondary foldable upper platform, and detachable cargo baskets, as best shown in FIGS. 7-9. The hand truck's stair-climbing components are similar to those described above with reference to FIGS. 1-6. Referring now to FIG. 7 there is shown a rigid hand truck frame 22, a rigid foldable upper platform 23, platform hinge mechanism 40, basket attachment point 45, and lower platform 27. In more detail, still referring to the exemplary embodiment of FIG. 7, the foldable upper platform 23 can pivot on hinge 24 and can be fixed either in a direction parallel to the frame 22 (see FIG. 9) or perpendicular to the frame 22 (see FIG. 7). Thus, it will be appreciated that the folding upper platform can be folded out of the way (against the frame 22 as in FIG. 9) such that a tall load may be carried on the lower platform without interference.

The various components may be constructed of any material with sufficient strength and rigidity to bear the intended loads, such as steel.

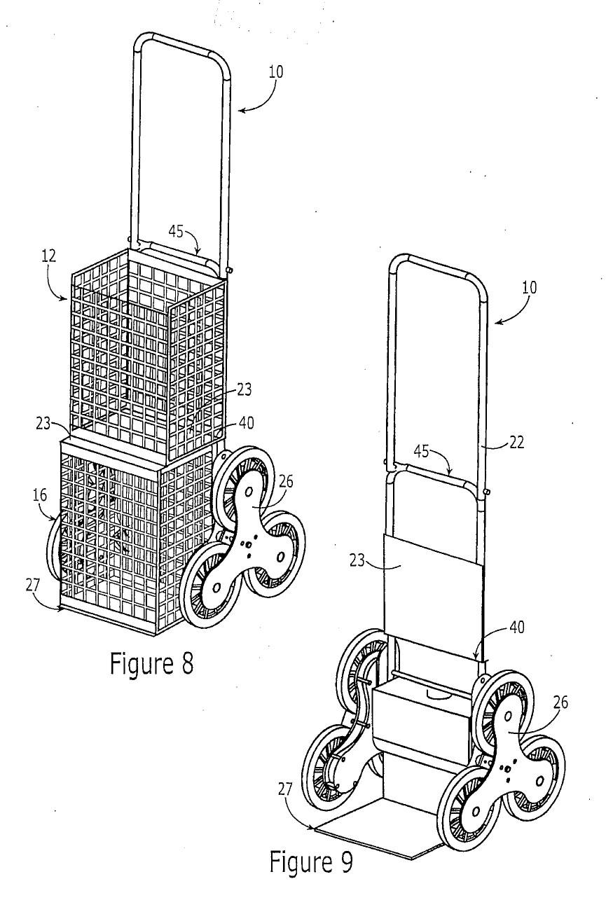

Referring now to FIG. 8, the hand truck 10 of FIGS. 7 and 9 is shown with an upper basket 12 and a lower basket 16 supported on the upper and lower platforms 23, 27, respectively. The baskets allow odd shaped or unstable loads to be constrained for safe transport, while being removable for larger loads. The upper basket and lower baskets 12, 16 can easily be attached or removed from frame 22 by mounting hooks of the baskets onto the frame, and allowing the baskets to hang from the frame. Preferably, the lower basket 16 is designed such that it fits within the confines of frame 22 and avoids contact with any moving parts of the hand truck. The upper and lower baskets are preferably constructed of a lightweight, crack-resistant material capable of meeting the strength requirements, such as any one of a variety of plastic materials.

It will be appreciated that the dual platform configuration allows two loads to be carried without having to stack them on top of each other. This can prevent breakage of fragile loads, and can increase stability for difficult to stack loads.

Thus, in the embodiment of FIGS. 7-9, the hand truck includes a platform 23 that is mounted on the frame 22 to be pivotable between an inoperable position, in which it lays against the frame of the hand truck, and an operable position, in which it extends substantially perpendicularly to the frame of the hand truck, and substantially parallel to a load-bearing platform 27 of the hand truck. In the operable position, the platform may be used to support a load, such as a box of heavy items, without need for stacking on any items positioned on the longer platform. The platform may be pivoted to the inoperable position to permit carrying of larger items on the lower platform 27, such as a golf bag, without interference with the platform. Further still, the frame may be configured with attachment points for supporting one or more removable baskets, each of which may be used to separately carry items, without a need for stacking the items upon one another on the platform. For example, a lower basket 16 may be carried on the lower platform 27, and a large box may be carried on the upper platform 23 pivoted to the operable position.

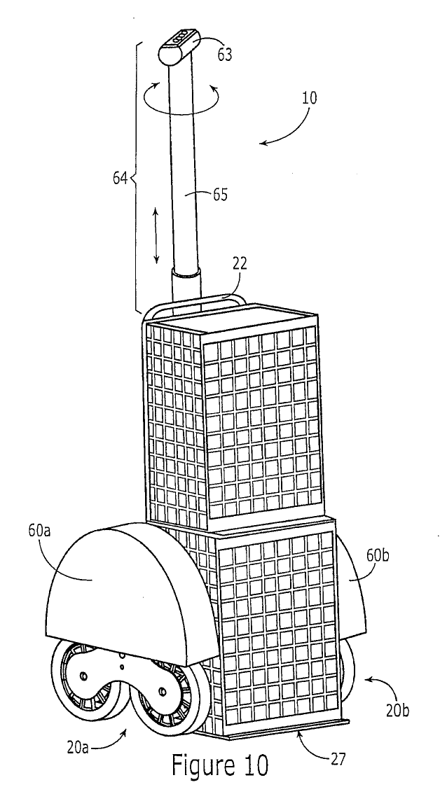

Optionally, a wheeled vehicle 10 in accordance with the present invention may include a pair of enclosures 60a, 60b mounted on the frame 22, each in position to partially enclose a respective spider assembly 20a, 20b during their rotation, and to shield the spider assemblies from a cargo area defined adjacent the lower platform 27 and the frame 22, as best shown in FIG. 10.

Optionally, the wheeled vehicle 10 may further include a telescoping, rotating control handle 64 supported on the frame 22, as shown in FIG. 10. The handle 64 consists of an ergonomic handle member 63 attached to a rigid shaft 65, which can both rotate and extend telescopically from a metal tube attached to the frame of the hand truck. The handle 64 can be adjusted by the user to whatever height is desired. The handle 63 member and telescoping shaft 65 can then be locked using a conventional locking mechanism, such as spring biased detent mechanisms, clamps, etc., such that further linear extension or retraction is prevented, while still allowing rotation to occur. The rotation feature improves ease of use by allowing the user to stand to either side of the unit while ascending or descending stairs without having to hold the handle at an uncomfortable angle. The control wires for the user interface may extend through the hollow handle member and/or hollow shaft 65. The handle may be limited to only 120 degrees of rotation by mechanical stops to prevent the internal wires from being excessively twisted or otherwise damaged.

Thus, a feature of vehicles in accordance with the present invention is accomplished fixing, e.g. locking or maintaining, the spider assemblies at a fixed angle relative to the frame through use of a feedback system utilizing a magnetic or other absolute angular position sensor, a controller, and the main drive motor. No pins, levers, or other mechanical locks are needed, which reduces the possibility of breakage.

Another feature of vehicles in accordance with certain embodiments of the present invention is the descent cycle variable-speed, angle-based braking. Spider assemblies have angular ranges/regions of inherent instability when descending stairs. In those regions, under certain conditions, a conventional spider assembly can roll off the edge of the stairs instead of synchronously rotating down them. In accordance with the present invention, an absolute angular position sensor detects the position of the spider assemblies and when within those regions, as determined by a pre-programmed controller, the controller actively accelerates the spider-assemblies through the regions of instability, greatly reducing the risk of rolling off the edge of the stairs. This feature greatly increases the safety and ease of use of the product, and is particularly useful for tri-wheel spider assemblies to acceptably meet the expectations of non-professional users.

Another feature of vehicles in accordance with the present invention is the integrated variable engagement clutch and brake system. This clutch can either lock the wheels to the same reference frame as the hand truck frame, or can allow them to spin freely. During ascent and descent modes, the clutch system is essential for providing added driving traction to force the hand truck to climb the stairs, rather than roll off or bounce in place. The clutch also can act as a brake to lock the hand truck to the stairs, reducing the possibility that it would roll off if the user were to stop at some point during ascent or descent. The clutch is electromagnetic and fully controlled by the controller; no user control is required.

Additional features include removable cargo baskets, and a dual-platform load-carrying system. All spider assembly designs must prevent the load from hitting or entangling in the rotating wheel assemblies. In accordance with the present invention, the vehicle may include wheel guarding enclosures, and cargo baskets that fit between the two spider assemblies, ensuring proper clearance. These baskets can be used to carry groceries, laundry, or any other typical household items. The dual-platform system allows tall, thin loads to be carried on the lower platform with the upper platform folded out of the way, while wide loads can be carried on the upper platform only, ensuring that the load will clear the rotating wheel assemblies.

Maneuvering of the hand truck on two wheels, rather than four, has been found to be advantageous to increase the maneuverability of the hand truck while being used on a substantially flat ground surface. As discussed above, previous designs have featured manually activated mechanical locking mechanisms, which typically use a locking pin or lever to fixedly lock each tri-wheel assembly to the hand truck's frame, to prevent its rotation. However, if the tri-wheel assembly is rigidly locked, a large bump, drop or other overload condition could bend or jam the locking mechanism. For motor-driven tri-wheel assemblies, if the user forgets that the tri-wheel assembly is locked and activates the motor, the motor could burn out or the gear train could be overloaded. Thus, such fixed mechanical locking mechanisms are prone to jamming, breakage, or motor stalling.

The discussion above includes a discussion of an electronically-controlled tri-wheel assembly locking mechanism that includes a controller, motor, angular position sensor, etc., and that provides an effective, low-cost solution to this problem, and that avoids mechanical failure in the event of an overload condition, by permitting movement, and subsequent relocking of the tri-wheel assembly. This system uses an angular position sensor to dynamically lock the position of the tri-wheel assembly, so that the unit may be easily balanced on two wheels, while imposing torque limits electronically, as discussed above.

The main limitation of such an electronically-controlled system is the power consumption requirement, which will deplete the battery if used for a long enough period of time. Since it may be necessary in some situations to roll the hand truck along level ground for substantial amounts of time, a lower power alternative wheel angle locking system is desired. Further, the electronic locking mechanism is only available when the hand truck has adequate electrical charge remaining in the battery, and consumes a significant amount of electric power when used for extended periods of operation.

Accordingly, further provided is a mechanical tri-wheel retention assembly that avoids rigid tri-wheel locking and associated mechanical failure in the event of an overload condition, and that also avoids extensive power consumption. The mechanical tri-wheel retention assembly that does not fixedly lock the tri-wheel assembly, and permits rotation and relocking of the tri-wheel assembly in the event of an overload condition. Unlike pin-type or level-type, or other manually-operated mechanical locks that fixedly lock the tri-wheel assembly to a frame, etc., the inventive mechanical tri-wheel locking assembly uses a tri-lobular roller cam mechanism to retain the tri-wheel at a desired angular position for normal two-wheeled operation, and further includes a spring-loaded roller that is configured to pop out of a locking mode in the event of an overload condition, permitting rotation of the tri-wheel assembly to a next predetermined angular position at which point the tri-wheel assembly will be retained, thus preventing damage to the unit and the locking mechanism.

The mechanical tri-wheel retention assembly may further include a solenoid actuator configured to automatically disengage the mechanical tri-wheel retention assembly. When used in combination with an electronically-controlled angular locking mechanism, this permits seamless transition to electronically-controlled locking mode. This eliminates the possibility of the unit stalling during an ascent attempt if the user forgot to disengage the wheel locks.

The mechanical tri-wheel retention assembly 10 uses a spring-biased cam roller that rides along a cam having detents located at predefined angular positions of the tri-wheel assembly, one corresponding to each wheel. These angular positions are defined to correspond to preferred angular positions of the tri-wheel assemblies that are appropriate for two-wheeled transport and turning.

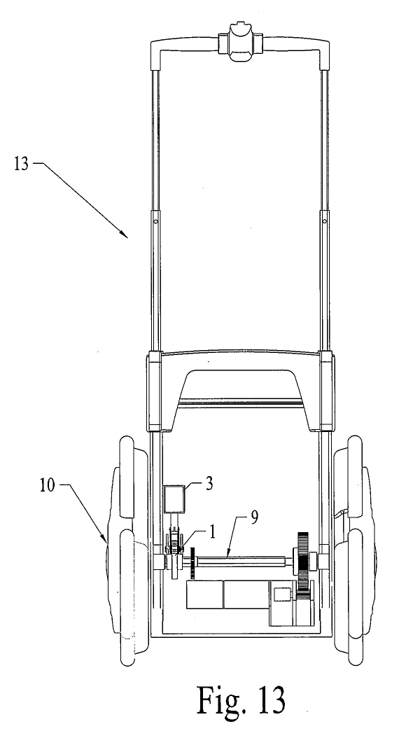

The cam is fixedly mounted to the main axle 9 of the hand truck 13 for synchronous rotation therewith, as best shown in FIGS. 13 and 15. In the event of an overload condition, the torque on the axle exceeds the spring force seating the roller in the detent, and the roller rides out of the detent, permitting the cam, axle, and tri-wheel assembly to rotate. This rotation continues until the next detent is reached, at which point the spring-biased roller seats in the next detent to retain the tri-wheel assembly in the next predefined angular position.

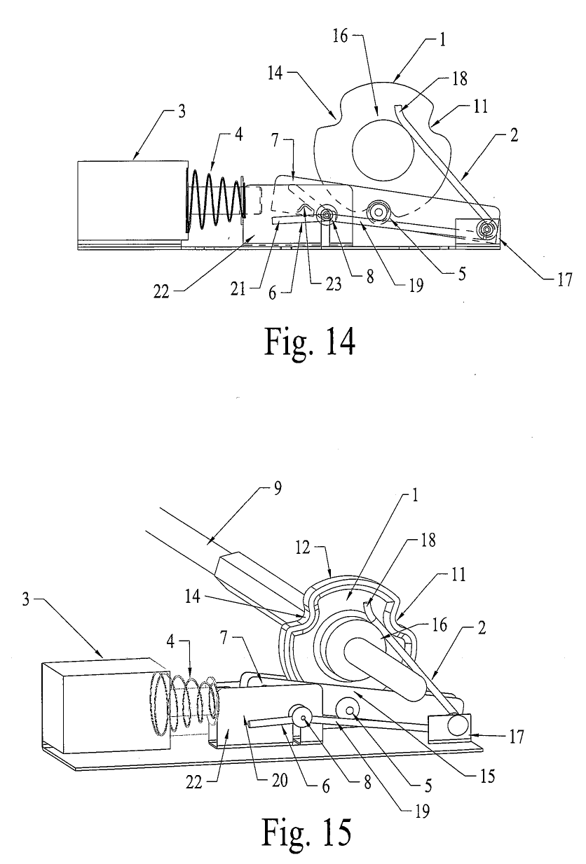

An exemplary tri-lobular cam 1 is shown in FIGS. 14 and 15. Each detent consists of an inwardly-extending recess 11 in the surface 12 of the cam 1. Each recess 11 is dimensioned to receive a cam roller 5, and preferably includes re-entrant sidewalls 14, 15, facilitating riding of the roller 5 out of the detent in the event of an overload condition. By way of example, the cam 1 may be manufactured of plastic, brass, or aluminum, depending on the load and cost constraints of the unit.

The cam roller 5 is biased into engagement with the cam surface 12 by spring 2. The cam roller 5 may be substantially cylindrical in shape, and thus tends to roll along cam surface 12. By way of example, the cam roller 5 may be constructed of steel or other suitable material.

Spring 2 is preferably constructed as a generally chevron-shaped resilient unitary body that is mounted to a housing 17 such that one end 18 of the body engages a central hub 16 of the cam 1, and the other end 19 abuts the roller 5. The ends of the spring are spread during manufacture to pretension the spring such that the tendency of the ends 19, 20 to resile spring-biases the roller 5 into engagement with the surface 12 of the cam 1.

Thus, spring 2 ensures that the cam roller 5 is forced tightly against the cam surface 12, such that it tends to seat in a detent at predefined angular positions, and thus to retain the interconnected tri-wheel assembly at the predefined angular position.

It will be noted, however, that in the event of an overload condition, the cam roller 5 can ride out of a detent on cam 1 and roll along the cam's outer surface 12, until the overload condition is abates, at which point the cam roller 5 will settle into the next detent. Thus, a mechanical angular retention assembly is provided that avoids breakage/damage in the event of an overload condition.

In an embodiment in which the mechanical angular retention assembly is employed in an electrically-powered hand truck having an electronically-controlled angular locking mechanism, the assembly may be further configured to disengage the mechanism angular retention assembly, e.g. to permit use instead of an electronically controlled angular locking mechanism. In such an embodiment, the assembly 10 further includes a solenoid coil 3 operably connected to a housing 22, and a guide pin 8 riding in a track of the housing 22, as best shown in FIG. 14. Further, a member joined to the spring 2 is configured with an upwardly sloping track 7, and the member includes a locking ramp 23.

When the unit is powered up and active electronic balancing is preferred, the locking mechanism is disengaged by the solenoid spring 4; such that is does not contribute to drag or inefficiency during operation.

In such an embodiment, when the hand truck 13 is powered on and use of the electronically controller angular locking mechanism is preferred, instead of the mechanical locking, the mechanical angular retention assembly is disengaged. Specifically, this is accomplished by a central control system (not shown) actuating the solenoid 3, which moves housing 22 to the left, as shown in FIG. 14. As housing 22 moves, guide pin 8 rides in track 7, which deflects the member and spring 2 downwardly. The guide pin 8 may ride over the locking ramp 23 and be retained behind a raised portion thereof by mechanical force. In this position, at least one spring end 2 is deflected outwardly, such that cam roller 5, mounted on the member, is retracted from the detents on cam 1 and will be held clear such that the shaft can rotate freely as-needed during stair-climbing operation.

When a return to un-powered passive mechanical angular locking is desired, the solenoid 3 is de-energized), and solenoid spring 4 causes the housing to return to the position shown in FIG. 14, the spring 2 then biasing cam roller 5 back into engagement with cam surface 12.

While there have been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

We claim:

1. A mechanical tri-wheel assembly retention mechanism, comprising:
a cam having an outer cam surface, said cam surface having a plurality of detents, each detent comprising an inwardly-extending recess;
a cam roller configured to ride along said outer cam surface; and
a spring biasing said cam roller into engagement with said cam surface.

2. A mechanical tri-wheel assembly retention mechanism, comprising:
a tri-lobular cam mounted on a drive shaft interconnected a pair of tri-wheel assemblies, said cam having a substantially-cylindrical outer cam surface, said cam defining a detent positioned between each pair of adjacent lobes, each detent each detent comprising an inwardly-extending recess having re-entrant sidewalls, each detent being positioned along said cam to correspond to a preferred angular position of said pair of tri-wheel assemblies;
a substantially cylindrical cam roller configured to ride along said outer cam surface; and
a resilient strap-like spring member supporting said cam roller, said spring member being tensioned to bias said cam roller into engagement with said cam surface.

3. The mechanical tri-wheel assembly retention mechanism of claim 2, further comprising:
a longitudinally slidable housing;
a solenoid operably connected to said housing,
a guide pin supported on said housing;
wherein said spring-like member comprises a track, and wherein energizing of said solenoid causes sliding movement of said housing and sliding movement of said guide pin in said track, said movement of said guide pin in said track displacing said spring-like member to disengage said cam roller from said cam surface.
